(19) United States
(12) Patent Application Publication
(10) Pub. No.: US 2026/0179303 A1
(43) Pub. Date: Jun. 25, 2026

(54) Sharing Matrix Core's Integer ALUs with Ray Tracing Hardware for Bulk Reduced Precision Ray-Triangle Pre-Filtering

(71) Applicant: Advanced Micro Devices, Inc., Santa Clara, CA (US)

(72) Inventor: Carsten Benthin, Voelklingen (DE)

(21) Appl. No.: 18/988,368

(22) Filed: Dec. 19, 2024

(51) Int. Cl. G06T 15/06

(52) U.S. Cl. CPC G06T 15/06

(57) ABSTRACT

An apparatus and method for efficiently managing ray tracing to increase performance are contemplated. In various implementations, a ray tracing circuit accesses a ray tracing queue and finds pre-filtering operations. The ray tracing circuit sends a pre-filtering request to an accelerator circuit targeting quantized geometry data. The request includes an identifier of a ray origin and a ray direction, a current intersection distance, a pointer to a memory location storing bounding volume hierarchy (BVH) tree information, an identifier of a corresponding video frame, and an additional pointer or other address indicator of a memory location storing quantized pre-filter information for multiple triangles. The accelerator utilizes its larger amount of hardware resources to execute the pre-filtering operations. Afterward, the ray tracing circuit performs the ray tracing operations using non-pre-filtered geometry data of a reduced number of triangles based on results of the pre-filtering operation performed by the accelerator circuit.

### DESCRIPTION OF THE RELEVANT ART

Highly parallel data applications are used in a variety of fields such as science, entertainment, finance, medical, engineering, social media, and so on. With an increased number of processing circuits in computing systems, the latency to deliver data to the processing circuits becomes emphasized. The performance, such as throughput, of the processing circuits depends on quick access to stored data. When performing ray tracing operations, various acceleration structures (data structures) are used to increase processing speed. A ray tracing circuit uses such structures to identify intersections of simulated light rays and objects in a scene of a video frame. To do so, the ray tracking circuit receives, from a parallel data processing circuit, data corresponding to simulated light rays (or rays) originating from a source, such as a point of view of a camera, and traveling in a particular direction.

The ray tracing circuit tracks paths within the scene of the image data until the ray intersects with an object in the scene. Increasing the hardware resources of the ray tracing circuit would increase throughput and performance. However, such an increase also would consume more on-die area.

In view of the above, methods and mechanisms for efficiently managing ray tracing to increase performance are desired.

### BRIEF DESCRIPTION OF THE DRAWINGS

FIG. 1 is a generalized diagram of an apparatus that efficiently manages ray tracing to increase performance.

FIG. 2 is a generalized diagram of a method for efficiently managing ray tracing to increase performance.

FIG. 3 is a generalized diagram of an apparatus that efficiently manages ray tracing to increase performance.

FIG. 4 is a generalized diagram of a method for efficiently managing ray tracing to increase performance.

FIG. 5 is a generalized diagram of a computing system that efficiently manages ray tracing to increase performance.

While the invention is susceptible to various modifications and alternative forms, specific implementations are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the scope of the present invention as defined by the appended claims.

### DETAILED DESCRIPTION

In the following description, numerous specific details are set forth to provide a thorough understanding of the present invention. However, one having ordinary skill in the art should recognize that the invention might be practiced without these specific details. In some instances, well-known circuits, structures, and techniques have not been shown in detail to avoid obscuring the present invention. Further, it will be appreciated that for simplicity and clarity of illustration, elements shown in the figures have not necessarily been drawn to scale. For example, the dimensions of some of the elements are exaggerated relative to other elements.

Apparatuses and methods for efficiently managing ray tracing to increase performance are contemplated. In various implementations, a computing system includes multiple processing circuits. Compute circuits of a parallel data processing circuit include at least single instruction multiple data (SIMD) circuits and generate multiple rays corresponding to a video frame. Examples of parallel data processing circuits are a graphics processing unit (GPU), a digital signal processing circuit (DSP), a field programmable gate arrays (FPGA), and an application specific integrated circuit (ASIC). The compute circuits send multiple rays to a queue of a ray tracing circuit. The ray tracing circuit accesses the multiple rays from the queue.

The ray tracing circuit generates a request to perform a bulk ray tracing pre-filtering operation. In an implementation, the request includes at least an identifier or indication of a ray origin and a ray direction, a current intersection distance, a pointer or other address indicator of a memory location storing bounding volume hierarchy (BVH) tree information, an additional pointer or other address indicator of a memory location storing quantized pre-filter information for multiple triangles, and so forth. The ray tracing circuit sends the request to an accelerator circuit.

In various implementations, examples of accelerator circuit are a field programmable gate array (FPGA), an embedded inference processing unit (EIPU) or an embedded inference processing circuit, an artificial intelligence (AI) accelerator processing circuit (an accelerator device), a neural processing unit (NPU) or a neural processing circuit, a tensor processing unit (TPU) or a tensor processing circuit, a multiprocessing circuit, and so on. The accelerator circuit includes multiple compute circuits, each with one or more of the integer arithmetic logic units (ALUs). In various implementations, accelerator circuit executes a variety of types of machine learning models such as at least a large language model (LLM), which includes multiple transformer stages relying on self-attention mathematical techniques for processing natural language processing (NLP) applications. The accelerator circuit accesses quantized geometry data corresponding to a scene of the video frame from one or more caches of the cache memory subsystem. accelerator circuit traces the rays of the bulk ray tracing pre-filtering operation using the quantized geometry data. For example, accelerator circuit accesses a shallow BVH tree structure with a smaller number of leaf nodes and a smaller number of levels than a non-pre-filtered version of the tree structure. Therefore, the latency reduces to build the BVH tree structure relying on quantized data. Accelerator circuit sends, to the ray tracing circuit, intersection information of the rays of the bulk ray tracing pre-filtering operation.

As the amount of hardware resources, such as the number of integer ALUs in accelerator circuit is much larger than the amount of hardware resources in the ray tracing circuit, it is more efficient to use the accelerator circuit instead of the ray tracing circuit for pre-filter ray tracing. Additionally, due to the large number of hardware resources, such as the number of integer ALUs, it is possible to use the ray-triangle pre-filtering technique, which allows efficient use of the hardware resources running the bulk pre-filter operations. The bulk pre-filter operations also provide the shallower BVH trees and therefore faster BVH build times. Further detail is provided in the following discussion.

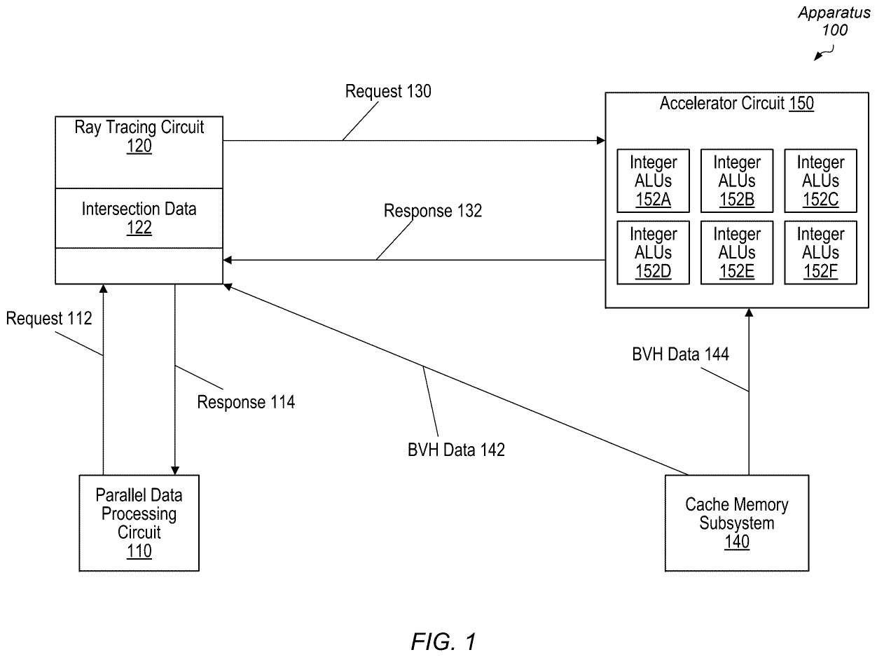

Turning now to FIG. 1, a block diagram is shown of an apparatus 100 that efficiently manages ray tracing to increase performance. As shown, apparatus 100 includes parallel data processing circuit 110, ray tracing circuit 120, cache memory subsystem 140 and accelerator circuit 150. A host processing circuit (not shown) includes a general-purpose processing circuit, such as a central processing unit (CPU), that translates instructions to commands for parallel data processing circuit 110 and accelerator circuit 150. Parallel data processing circuit 110 has a highly parallel data microarchitecture. Examples of parallel data processing circuit 110 are a graphics processing unit (GPU), a digital signal processing circuit (DSP), a field programmable gate arrays (FPGA), and an application specific integrated circuit (ASIC). In various implementations, examples of accelerator circuit 550 are a field programmable gate array (FPGA), an embedded inference processing unit (EIPU) or an embedded inference processing circuit, an artificial intelligence (AI) accelerator processing circuit (an accelerator device), a neural processing unit (NPU) or a neural processing circuit, a tensor processing unit (TPU) or a tensor processing circuit, a multiprocessing circuit, and so on.

In other implementations, apparatus 100 includes other components or is arranged differently. For example, power management circuitry, and phased locked loops (PLLs) or other clock generating circuitry are not shown for ease of illustration. In various implementations, the components of the apparatus 100 are on the same die such as a system-on-a-chip (SOC). In other implementations, the components are individual dies in a system-in-package (SiP) or a multi-chip module (MCM). A variety of computing devices use the apparatus 100 such as a desktop computer, a laptop computer, a server computer, a tablet computer, a smartphone, a gaming device, a smartwatch, and so on.

Compute circuits of parallel data processing 110 include one or more of single instruction multiple data (SIMD) circuits and multiple instruction multiple data (MIMD) circuits and generate multiple rays corresponding to a video frame. In request 112, the compute circuits send multiple rays to a queue of ray tracing circuit 120. The ray tracing circuit 120 accesses the multiple rays from the queue (not shown). In some implementations, the request 112 stored in the queue includes at least an identifier or indication of a ray origin and a ray direction, a current intersection distance, a pointer or other address indicator of a memory location storing bounding volume hierarchy (BVH) tree information, an identifier of a corresponding video frame, and so forth. The ray tracing circuit 120 generates a request 130 to perform a bulk ray tracing pre-filtering operation. In an implementation, request 130 includes the same information as the request in the queue with additional pointer or other address indicator of a memory location storing quantized pre-filter information for multiple triangles. The ray tracing circuit 120 sends the request 130 to the accelerator circuit 150. In various implementations, the BVH tree information is stored in cache memory subsystem 140.

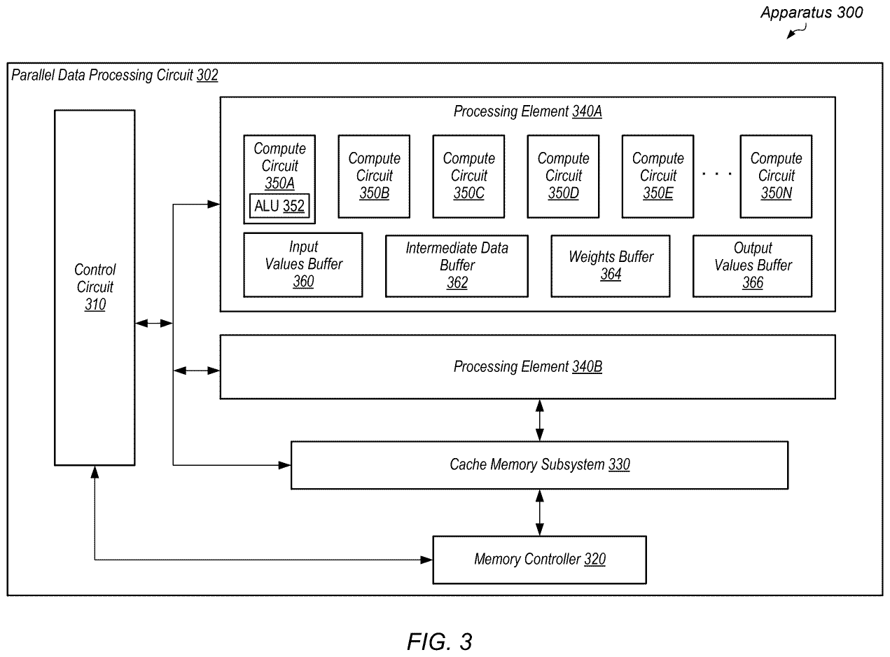

Accelerator circuit includes multiple compute circuits, each with one or more of the integer arithmetic logic units (ALUs) 152A-152F. A further description of one implementation of the accelerator circuit 150 is provided in the description of apparatus 300 (of FIG. 3). In various implementations, accelerator circuit 150 executes a variety of types of machine learning models such as at least a large language model (LLM), which includes multiple transformer stages relying on self-attention mathematical techniques for processing natural language processing (NLP) applications. The accelerator circuit 150 accesses quantized geometry data corresponding to a scene of the video frame from one or more caches of the cache memory subsystem 140. The quantized data is in BVH data 144. The accelerator circuit 150 traces the rays of the bulk ray tracing pre-filtering operation using the quantized geometry data. For example, accelerator circuit 150 accesses a shallow BVH tree structure with a smaller number of leaf nodes and a smaller number of levels than a non-quantized version of the tree structure. Therefore, the latency reduces to build the BVH tree structure relying on quantized data. Accelerator circuit 150 sends, to the ray tracing circuit 120 in response 132, intersection information of the rays of the bulk ray tracing pre-filtering operation.

The larger number of integer ALUs 152A-152F in accelerator circuit 150 compared to the number of integer ALUs in ray tracing circuit 120 allow for accelerator circuit 150 to perform a larger number of pre-filter tests in parallel, which is more efficient than performing the pre-filter tests sequentially within ray tracing circuit 120. Additionally, due to the large number of hardware resources, such as integer ALUs 152A-152F, it is possible to use the ray-triangle pre-filtering technique, which allows efficient use of the hardware resources running the bulk pre-filter operations. The bulk pre-filter operations also provide shallower BVH trees and therefore faster BVH build times.

The ray tracing circuit 120 completes the ray tracing operation using non-pre-filtered geometry data of a reduced number of triangles. The non-pre-filtered geometry data is in BVH 142. For example, the bulk ray tracing pre-filtering operation performed by the accelerator circuit 150 narrowed the area to search for ray intersection information to a particular area of the scene of the video frame. For example, the bulk triangle pre-filtering reduces the number of full ray-triangle intersection tests that have to be performed per ray. Afterward, the compute circuits of the parallel data processing circuit 110 accesses the intersection information 122 from the queue due to response 114.

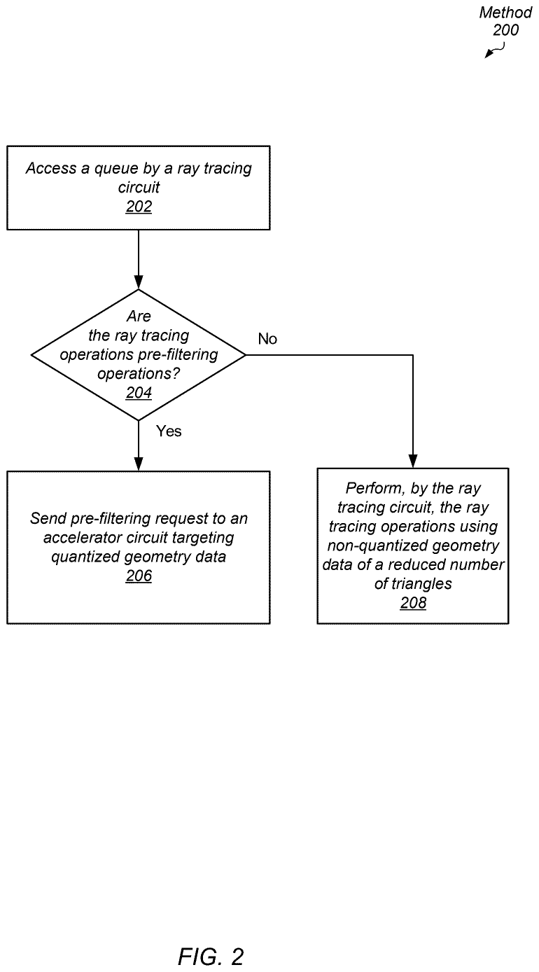

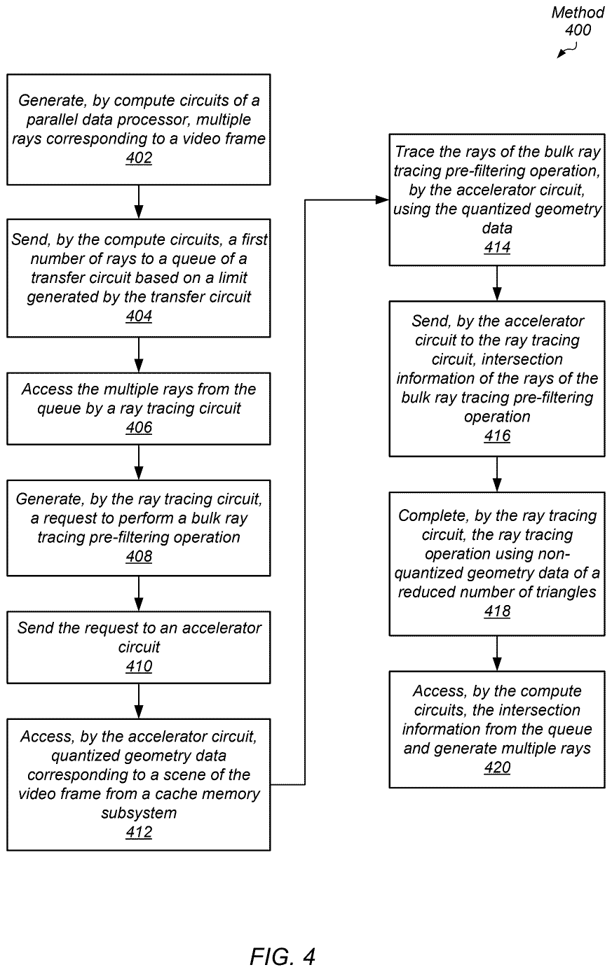

For the methods 200 and 400 (of FIGS. 2 and 4), a computing system includes multiple processing circuits. A host processing circuit of the multiple processing circuits is a general-purpose processing circuit, such as a central processing unit (CPU). Another processing circuit of the multiple processing circuits is a parallel data processing circuit with a highly parallel data microarchitecture. Examples of this processing circuit are a graphics processing unit (GPU), a digital signal processing circuit (DSP), a field programmable gate arrays (FPGA), and an application specific integrated circuit (ASIC). The parallel data processing circuit communicates with a ray tracing circuit.

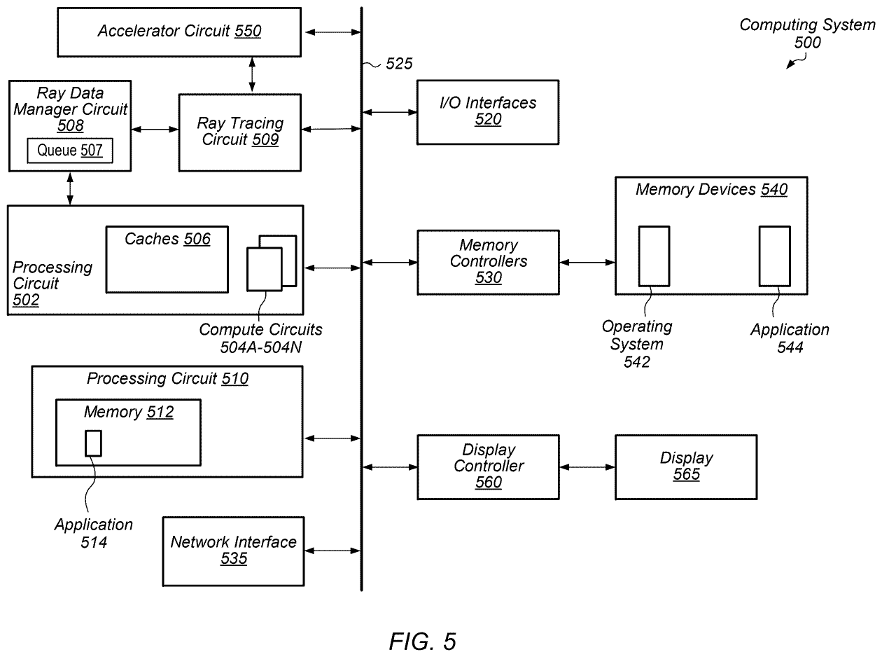

In various implementations, the host processing circuit converts (translates) the instructions of a highly parallel data application, such as a video graphics application, to commands. The host processing circuit stores the commands in a buffer (e.g., a ring buffer, or otherwise) in system memory. The parallel data processing circuit reads the commands from the buffer. Similarly, the host processing circuit converts (translates) the instructions of a machine learning (ML) model application to commands for execution by the accelerator circuit. In various implementations, the accelerator circuit has the same functionality as the accelerator circuit 150 (of FIG. 1) and apparatus 300 (of FIG. 3) and accelerator circuit 550 (of FIG. 5).

Referring to FIG. 2, a generalized block diagram is shown of a method 200 for efficiently managing ray tracing to reduce cache contention. For purposes of discussion, the steps in this implementation (as well as FIG. 4) are shown in sequential order. However, in other implementations some steps occur in a different order than shown, some steps are performed concurrently, some steps are combined with other steps, and some steps are absent.

A ray tracing circuit accesses a ray tracing queue (block 202). If the ray tracing operations stored in the queue are the ray tracing pre-filtering operations (“yes” branch of the conditional block 204), then the ray tracing circuit sends a pre-filtering request to an accelerator circuit targeting quantized geometry data (block 206). In some implementations, the request includes at least an identifier or indication of a ray origin and a ray direction, a current intersection distance, a pointer or other address indicator of a memory location storing bounding volume hierarchy (BVH) tree information, an identifier of a corresponding video frame, an additional pointer or other address indicator of a memory location storing quantized pre-filter information for multiple triangles, and so forth.

If the ray tracing operations stored in the queue are not the ray tracing pre-filtering operations (“no” branch of the conditional block 204), then the ray tracing circuit performs the ray tracing operations using non-pre-filtered geometry data of a reduced number of triangles. For example, the bulk ray tracing pre-filtering operation performed by the accelerator circuit narrows the area to search for ray tracing to a particular area of the scene of the video frame. Afterward, the compute circuits of the parallel data processing circuit access the intersection information from the queue and generate multiple rays.

Turning now to FIG. 3, a block diagram is shown of an apparatus 300 that performs efficient data storage and data transfer of machine learning data. In one implementation, apparatus 300 includes parallel data processing circuit 302. As shown, parallel data processing circuit 302 includes control circuit 310, memory controller 320, cache memory subsystem 330 and processing elements 340A-340B. Examples of parallel data processing circuit 302 are the same as examples of accelerator circuit 952 (of FIG. 9). In various implementations, parallel data processing circuit 302 executes a variety of types of parallel data applications such as machine learning (ML) models. For example, parallel data processing circuit 302 executes instructions of nodes, layers and stages of a ML model in a computational order of a computational graph such as computational graph 700 (of FIG. 7).

Parallel data processing circuit 302 includes at least control circuit 310, processing elements 340A-340B, cache memory subsystem 330, and memory controller 320. Each of processing elements 340A-340B includes the multiple compute circuits 350A-350N and multiple buffers such as input values buffer 360, intermediate data buffer 362, weights buffer 364 and output values buffer 366. In various implementations, one or more of the compute circuits 350A-350N includes an integer ALU 352. It should be understood that the components and connections shown for parallel data processing circuit 302 are merely representative of one type of processing circuit and does not preclude the use of other types of processing circuits for implementing the techniques presented herein.

The apparatus 300 also includes other components which are not shown to avoid obscuring the figure such as at least a communication fabric, one or more system buses, clock signal generating circuitry, power management circuitry, input/output (I/O) interfaces and so on. In other implementations, the parallel data processing circuit 302 includes other components, omits one or more of the illustrated components, has multiple instances of a component even if only one instance is shown in the apparatus 300, and/or is organized in other suitable manners. Also, each connection shown in apparatus 300 is representative of any number of connections between components. Additionally, other connections can exist between components even if these connections are not explicitly shown in apparatus 300.

Although a single memory controller 320 is shown, it is possible and contemplated that parallel data processing circuit 302 includes multiple memory controllers supporting one or more communication protocols with a variety of data storage devices. In an implementation, memory controller 320 (and any other memory controller) directly communicates with each of the processing elements 340A-340B and cache memory subsystem 330 and includes circuitry for supporting communication protocols and queues for storing requests and responses. As part of executing an application, such as a ML model, a host CPU (not shown) launches kernels to be executed by parallel data processing circuit 302. Control circuit 310 receives kernels from the host CPU either directly or via system memory and determines when to dispatch kernels for execution on compute circuits 350A-350N of processing elements 340A-340B.

Parallel threads executing on compute circuits 350A-350N read data from and write data to the cache memory subsystem 330, vector general-purpose registers, scalar general-purpose registers, and one or more of buffers 360-366. In various implementations, the circuitry of processing element 340B is a replicated instantiation (or silicon integrated circuit copy) of the circuitry of processing element 340A. In some implementations, each of the processing elements 340A-340B is a chiplet. As used herein, a “chiplet” is a semiconductor die (or die) fabricated separately from other dies, and then interconnected with these other dies in a single integrated circuit in the multi-chip module (MCM). On a single silicon wafer, multiple chiplets can be fabricated as multiple instances of particular integrated circuitry. A first silicon wafer (or first wafer) is fabricated with multiple instances of integrated circuitry of a first chiplet, and this first wafer is diced using laser cutting techniques to separate the multiple copies of the first chiplet. A second silicon wafer (or second wafer) is fabricated with multiple instances of integrated circuitry of a second chiplet, and this second wafer is diced using laser cutting techniques to separate the multiple copies of the second chiplet.

In an implementation, each of the multiple compute circuits 350A-350N includes one or more vector processing circuits with circuitry of multiple parallel computational lanes of simultaneous execution. These parallel computational lanes operate in lockstep. In various implementations, the data flow within each of the lanes is pipelined. Pipeline registers are used for storing intermediate results and circuitry for arithmetic logic units (ALUs) perform integer arithmetic, floating-point arithmetic, Boolean logic operations, branch condition comparisons and so forth. These components are not shown for ease of illustration. Each of the ALUs within a given row across the lanes includes the same circuitry and functionality, and operates on the same instruction, but different data, such as a different data item, associated with a different thread.

In addition to the multiple vector processing circuits, compute circuits 350A-350N also include an assigned number of vector general-purpose registers (VGPRs), an assigned number of scalar general-purpose registers (SGPRs), and an assigned data storage space of one or more of buffers 360-366. Schedulers in one or more of control circuit 310, processing elements 340A-340B and compute circuits 350A-350N receive instructions, such as instructions of stages, layers and nodes of a ML model, and determine when to execute the instructions.

Referring to FIG. 4, a generalized block diagram is shown of a method 400 for efficiently managing ray tracing to reduce cache contention. For purposes of discussion, the steps in this implementation (as well as in FIG. 2) are shown in sequential order. However, in other implementations some steps occur in a different order than shown, some steps are performed concurrently, some steps are combined with other steps, and some steps are absent.

Compute circuits of a parallel data processor generate multiple rays corresponding to a video frame (block 402). The compute circuits send multiple rays to a queue of a ray tracing circuit (block 404). The ray tracing circuit accesses the multiple rays from the queue (block 406). In some implementations, the request stored in the queue includes at least an identifier or indication of a ray origin and a ray direction, a current intersection distance, a pointer or other address indicator of a memory location storing bounding volume hierarchy (BVH) tree information, an identifier of a corresponding video frame, and so forth. The ray tracing circuit generates a request to perform a bulk ray tracing pre-filtering operation (block 408). In an implementation, the request includes the same information as the request in the queue with additional pointer or other address indicator of a memory location storing quantized pre-filter information for multiple triangles. The ray tracing circuit sends the request to the accelerator circuit (block 410).

The accelerator circuit accesses quantized geometry data corresponding to a scene of the video frame from one or more caches of the cache memory subsystem (block 412). The accelerator circuit traces the rays of the bulk ray tracing pre-filtering operation using the quantized geometry data (block 414). For example, the accelerator circuit accesses a shallow BVH tree structure with a smaller number of leaf nodes and a smaller number of levels of the tree structure. Therefore, the latency reduces to build the BVH tree structure relying on quantized data. The accelerator circuit sends, to the ray tracing circuit, intersection information of the rays of the bulk ray tracing pre-filtering operation (block 416). The ray tracing circuit completes the ray tracing operation using non-pre-filtered geometry data of a reduced number of triangles (block 418). For example, the bulk ray tracing pre-filtering operation performed by the accelerator circuit narrowed the area to search for ray tracing to a particular area of the scene of the video frame. Afterward, the compute circuits of the parallel data processing circuit access the intersection information from the queue (block 420).

Turning now to FIG. 5, a generalized diagram is shown of a computing system 500 that efficiently manages ray tracing to increase performance. In an implementation, computing system 500 includes at least processing circuits 502 and 510, ray data manager circuit 508, ray tracing circuit 509, accelerator circuit 550, input/output (I/O) interfaces 520, bus 525, network interface 535, memory controllers 530, memory devices 540, display controller 560, and display 565. In other implementations, computing system 500 includes other components and/or computing system 500 is arranged differently. For example, power management circuitry, and phased locked loops (PLLs) or other clock generating circuitry are not shown for ease of illustration. In various implementations, the components of the computing system 500 are on the same die such as a system-on-a-chip (SOC). In other implementations, the components are individual dies in a system-in-package (SiP) or a multi-chip module (MCM). A variety of computing devices use the computing system 500 such as a desktop computer, a laptop computer, a server computer, a tablet computer, a smartphone, a gaming device, a smartwatch, and so on.

Processing circuits 502 and 510 are representative of any number of processing circuits which are included in computing system 500. In an implementation, processing circuit 510 is a general-purpose central processing unit (CPU). In one implementation, processing circuit 502 is a parallel data processing circuit with a highly parallel data microarchitecture, such as a GPU. The processing circuit 502 can be a discrete device, such as a dedicated GPU (dGPU), or the processing circuit 502 can be integrated (an iGPU) in the same package as another processing circuit. Other parallel data processing circuits that can be included in computing system 500 include digital signal processing circuits (DSPs), field programmable gate arrays (FPGAs), application specific integrated circuits (ASICs), and so forth. In various implementations, examples of accelerator circuit 550 are a field programmable gate array (FPGA), an embedded inference processing unit (EIPU) or an embedded inference processing circuit, an artificial intelligence (AI) accelerator processing circuit (an accelerator device), a neural processing unit (NPU) or a neural processing circuit, a tensor processing unit (TPU) or a tensor processing circuit, a multiprocessing circuit, and so on. In an implementation, ray tracing circuit 509 has the same functionality as ray tracing circuit 120 (of FIG. 1), processing circuit 502 has the same functionality as parallel data processing circuit 110 (of FIG. 1), and accelerator circuit 550 has the same functionality as accelerator circuit 150 (of FIG. 1).

In various implementations, the processing circuit 502 includes multiple, replicated compute circuits 504A-504N, each including similar circuitry and components such as single instruction multiple data (SIMD) circuits, the caches 506, and hardware resources (not shown). Caches 506 represent the cache memory subsystem of processing circuit 502. The SIMD circuits of the compute circuits 504A-504N includes multiple, parallel computational lanes.

In some implementations, each of the application 544 stored on the memory devices 540 and its copy (application 514) stored on the memory 512 is a highly parallel data application such as a video graphics application. The highly parallel data application includes function calls that allow the developer to insert requests in the highly parallel data application for launching wavefronts of a kernel (function call). In various implementations, processing circuit 510 converts (translates) the instructions of the highly parallel data application to commands. In various implementations, the processing circuit 510 stores the commands in a buffer in system memory provided by memory devices 540. Processing circuit 502 reads the commands from the buffer in the system memory provided by memory devices 540. In an implementation, the buffer includes multiple storage locations of the memory devices 540 used to provide a memory mapped input/output (MMIO) first-in-first-out (FIFO) buffer. The high parallelism offered by the hardware of the compute circuits 504A-504N is used for real-time data processing. Examples of real-time data processing are rendering multiple pixels, image blending, pixel shading, vertex shading, and geometry shading. In such cases, each of the data items of a wavefront is a pixel of an image. In a similar manner, processing circuit 510 converts (translates) the instructions of a machine learning (ML) model application to commands for accelerator circuit 550.

Memory 512 represents a local hierarchical cache memory subsystem. Memory 512 stores source data, intermediate results data, results data, and copies of data and instructions stored in memory devices 540. Processing circuit 510 is coupled to bus 525 via interface 506. Processing circuit 510 receives, via interface 506, copies of various data and instructions, such as the operating system 542, one or more device drivers, one or more applications such as application 504, and/or other data and instructions. The processing circuit 510 retrieves a copy of the application 544 from the memory devices 540, and the processing circuit 510 stores this copy as application 514 in memory 512.

In some implementations, computing system 500 utilizes a communication fabric (“fabric”), rather than the bus 525, for transferring requests, responses, and messages between the processing circuits 502 and 510, the I/O interfaces 520, the memory controllers 530, the network interface 535, and the display controller 550. Memory controllers 530 are representative of any number and type of memory controllers accessible by processing circuits 502 and 510. While memory controllers 530 are shown as being separate from processing circuits 502 and 510, it should be understood that this merely represents one possible implementation. In other implementations, one of memory controllers 530 is embedded within one or more of processing circuits 502 and 510 or it is located on the same semiconductor die as one or more of processing circuits 502 and 510. Memory controllers 530 are coupled to any number and type of memory devices 540.

Memory devices 540 are representative of any number and type of memory devices. For example, the type of memory in memory devices 540 includes Dynamic Random Access Memory (DRAM), Static Random Access Memory (SRAM), NAND Flash memory, NOR flash memory, Ferroelectric Random Access Memory (FeRAM), or otherwise. Memory devices 540 store at least instructions of an operating system 542, one or more device drivers, and application 504. In some implementations, application 504 is a highly parallel data application such as a video graphics application, a shader application, or other. Copies of these instructions can be stored in a memory or cache device local to processing circuit 510 and/or processing circuit 502.

I/O interfaces 520 are representative of any number and type of I/O interfaces (e.g., peripheral component interconnect (PCI) bus, PCI-Extended (PCI-X), PCIE (PCI Express) bus, gigabit Ethernet (GBE) bus, universal serial bus (USB). Various types of peripheral devices (not shown) are coupled to I/O interfaces 520. Such peripheral devices include (but are not limited to) displays, keyboards, mice, printers, scanners, joysticks or other types of game controllers, media recording devices, external storage devices, and so forth. Network interface 535 receives and sends network messages across a network.

It is noted that one or more of the above-described implementations include software. In such implementations, the program instructions that implement the methods and/or mechanisms are conveyed or stored on a computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage. Generally speaking, a computer accessible storage medium includes any storage media accessible by a computer during use to provide instructions and/or data to the computer. For example, a computer accessible storage medium includes storage media such as magnetic or optical media, e.g., disk (fixed or removable), tape, CD-ROM, or DVD-ROM, CD-R, CD-RW, DVD-R, DVD-RW, or Blu-Ray. Storage media further includes volatile or non-volatile memory media such as RAM (e.g., synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g., Flash memory) accessible via a peripheral interface such as the Universal Serial Bus (USB) interface, etc. Storage media includes microelectromechanical systems (MEMS), as well as storage media accessible via a communication medium such as a network and/or a wireless link.

Additionally, in various implementations, program instructions include behavioral-level descriptions or register-transfer level (RTL) descriptions of the hardware functionality in a high-level programming language such as C, or a design language (HDL) such as Verilog, VHDL, or database format such as GDS II stream format (GDSII). In some cases, the description is read by a synthesis tool, which synthesizes the description to produce a netlist including a list of gates from a synthesis library. The netlist includes a set of gates, which also represent the functionality of the hardware including the system. The netlist is then placed and routed to produce a data set describing geometric shapes to be applied to masks. The masks are then used in various semiconductor fabrication steps to produce a semiconductor circuit or circuits corresponding to the system. Alternatively, the instructions on the computer accessible storage medium are the netlist (with or without the synthesis library) or the data set, as desired. Additionally, the instructions are utilized for purposes of emulation by a hardware-based type emulator from such vendors as Cadence®, EVE®, and Mentor Graphics®.

Although the implementations above have been described in considerable detail, numerous variations and modifications will become apparent to those skilled in the art once the above disclosure is fully appreciated. It is intended that the following claims be interpreted to embrace all such variations and modifications.

What is claimed is

1. An apparatus comprising:
circuitry configured to:
access a first operation in a queue; and
responsive to the first operation being of a first type, convey, to a processing circuit, a request to complete the first operation using quantized data.

2. The apparatus as recited in claim 1, wherein the circuitry is configured to:
access a second operation in the queue; and
responsive to the second operation being of a second type different from the first type, execute the second operation using non-pre-filtered data.

3. The apparatus as recited in claim 2, wherein the first type is a ray tracing pre-filtering operation.

4. The apparatus as recited in claim 1, wherein the processing circuit is an accelerator circuit configured to execute a machine learning model.

5. The apparatus as recited in claim 1, wherein the processing circuit comprises a larger number of a computational resource than the apparatus.

6. The apparatus as recited in claim 5, wherein the hardware resource is an integer arithmetic logic unit.

7. The apparatus as recited in claim 1, wherein the circuitry is configured to generate ray data based on image data.

8. A method, comprising:
accessing, by a first processing circuit, a first operation in a queue; and
responsive to the first operation being of a first type, conveying, by the first processing circuit to a second processing circuit, a request to complete the first operation using quantized data.

9. The method as recited in claim 8, further comprising:
Accessing, by the first processing circuit, a second operation in the queue; and
responsive to the second operation being of a second type different from the first type, executing, by the first processing circuit, the second operation using non-pre-filtered data.

10. The method as recited in claim 8, wherein the first type is a ray tracing pre-filtering operation.

11. The method as recited in claim 8, wherein the processing circuit is an accelerator circuit configured to execute a machine learning model.

12. The method as recited in claim 8, wherein the processing circuit comprises a larger number of a computational resources than the apparatus.

13. The method as recited in claim 12, wherein the hardware resource is an integer arithmetic logic unit.

14. The method as recited in claim 8, further comprising generating, by the first processing circuit, ray data based on image data.

15. A computing system comprising:
a cache memory subsystem;
a first processing circuit; and
a second processing circuit; and
wherein the first processing circuit is configured to:
access a first operation in a queue; and
responsive to the first operation being of a first type, convey, to the second processing circuit, a request to complete the first operation using quantized data stored in the cache memory subsystem.

16. The computing system as recited in claim 15, wherein the first processing circuit is configured to:
access a second operation in the queue; and
responsive to the second operation being of a second type different from the first type, execute the second operation using non-pre-filtered data stored in the cache memory subsystem.

17. The computing system as recited in claim 16, wherein the first type is a ray tracing pre-filtering operation.

18. The computing system as recited in claim 15, wherein the processing circuit is an accelerator circuit configured to execute a machine learning model.

19. The computing system as recited in claim 15, wherein the second processing circuit comprises a larger number of a hardware resource than the first processing circuit.

20. The computing system as recited in claim 19, wherein the hardware resource is an integer arithmetic logic unit.
